(19) United States
(12) Patent Application Publication
(10) Pub. No.: US 2019/0210561 A1
(43) Pub. Date: Jul. 11, 2019

(54) METHOD FOR CONTROLLING AN ACCESS AUTHORIZATION AND/OR DRIVE AUTHORIZATION FOR A VEHICLE

(71) Applicant: DAIMLER AG, Stuttgart (DE)

(72) Inventor: Robin MIDDELANIS, Bielefeld (DE)

(21) Appl. No.: 16/332,525

(22) PCT Filed: Aug. 25, 2017
(86) PCT No.: PCT/EP2017/001011

§ 371 Date: Mar. 12, 2019

(30) Foreign Application Priority Data
Sep. 27, 2016 (DE) 10 2016 011 654.4

(51) Int. Cl. B60R 25/24; G07C 9/00

(52) U.S. Cl. CPC B60R 25/241; G07C 9/00309; G07C 2209/65; G07C 2009/00555; G07C 2009/0038

(57) ABSTRACT

A method for controlling access authorization and/or driving authorization for a vehicle, involves establishing a wireless link between a mobile communications unit and an on-board control unit when the mobile communications unit is located at a predetermined distance from the vehicle. The mobile communications unit transmits authorization data to release the access authorization and/or driving authorization to the on-board control unit, and the on-board control unit receives and checks the authorization data. The access authorization and/or driving authorization is/are released upon successful authorization of the authorization data by the on-board control unit. The authorization data are transmitted from the mobile communications unit exclusively when, after the link between the mobile communications unit and the on-board control unit has been established, a predefined or predefinable knocking gesture is made on and detected by the mobile communications unit.

### BACKGROUND AND SUMMARY OF THE INVENTION

Exemplary embodiments of the invention relate to a method for controlling access authorization and/or driving authorization for a vehicle.

Methods for controlling access authorization and/or driving authorization for a vehicle are known from the prior art. For example, a security system for securing a vehicle against theft is described in DE 10 2014 207 809 A1, wherein a terminal, such as a smartphone, is used to open and close the vehicle by actuating a button on the terminal. To deactivate levels of security in the vehicle, an acoustic sensor can be applied on the exterior of the vehicle, which serves for the input of the knock signal. When the knock signal is entered correctly, the security level is turned on or off.

Exemplary embodiments of the invention are directed to a method for controlling access authorization and/or driving authorization for a vehicle, which is improved with respect to the prior art.

In a method for controlling access authorization and/or driving authorization for a vehicle, a wireless link is established between a mobile communications unit and an on-board control unit when the mobile communications unit is located at a predetermined distance from the vehicle, wherein the mobile communications unit transmits authorization data to release the access authorization and/or driving authorization to the on-board control unit, and the on-board control unit receives and checks the authorization data, and wherein the access authorization and/or driving authorization are released upon successful authorization of the authorization data by means of the on-board control unit.

In particular, the mobile communications unit is a remote control for a keyless access authorization system and driving authorization system of the vehicle, also known as the “Keyless Go” system. In other words, the mobile communications unit grants a user of the vehicle authorized access to the vehicle by unlocking one or more vehicle doors and also permits a likewise keyless ignition of the driving motor of the vehicle e.g., by means of a start button in the vehicle. The mobile communications unit is a smartphone or a tablet computer, for example.

According to the invention, the authorization data are transmitted from the mobile communications unit exclusively when, after the link between the mobile communications unit and the on-board control unit has been established, a predefined or predefinable knocking gesture is made on and detected by the mobile communications unit.

The method permits a keyless access authorization and driving authorization system of the vehicle to be protected from so-called relay attacks (also known as relay station attacks), in which, with the aid of two relay stations, the range of communication between the on-board control unit and the mobile communications unit is increased to an extent required for misuse. Moreover, the convenience for the user when unlocking and/or starting the vehicle is improved over the prior art by means of the method. It is sufficient here for the mobile communications unit to be located in any arbitrary location with the user of the vehicle.

Exemplary embodiments of the invention are discussed below in greater detail on the basis of a drawing.

### BRIEF DESCRIPTION OF THE DRAWING FIGURE

The following is shown:

FIG. 1 a schematic representation of a method for controlling access authorization and/or driving authorization for a vehicle.

### DETAILED DESCRIPTION

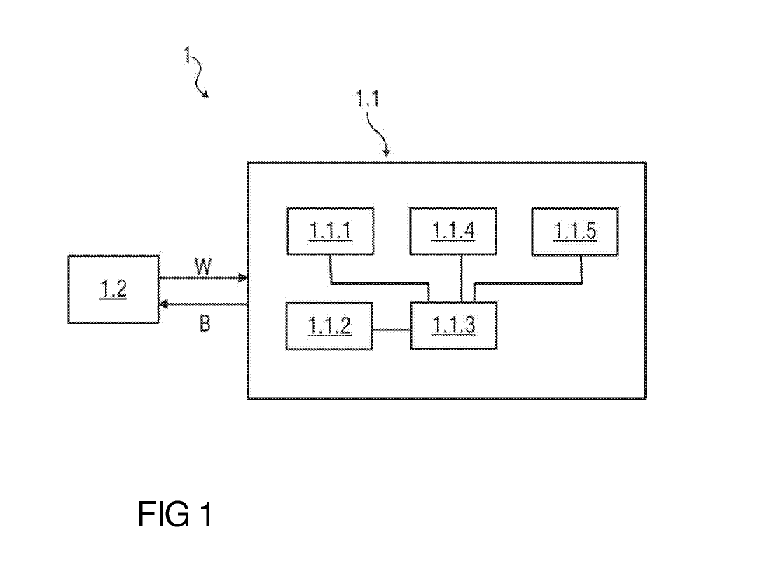

The single FIG. 1 shows a block diagram of an exemplary embodiment of a device 1 for carrying out a method for controlling access authorization and/or driving authorization for a vehicle, which is not shown in detail.

The device 1 is a component of a keyless access authorization and driving authorization system of the vehicle. In other words, the device 1 grants a user of the vehicle access to the vehicle by unlocking one or more vehicle doors and, advantageously, also permits a likewise keyless ignition of the driving motor of the vehicle, for example, by means of a start button in the vehicle, which is designated the start-stop button. The access authorization and driving authorization system is also known as a so-called “Keyless Go” system.

The device 1 comprises a mobile communications unit 1.1 that, for instance, is integrated into a mobile terminal, such as a smartphone or a tablet computer, or into a vehicle key. Furthermore, the device 1 comprises an on-board control unit 1.2, which is arranged in or on the vehicle.

The mobile communications unit 1.1 has a plurality of antenna units 1.1.1, 1.1.2, wherein a receiving antenna unit 1.1.1 is configured, for instance, to receive a low-frequency wake-up signal W transmitted by the on-board control unit 1.2. The wake-up signal W is received when the mobile communications unit 1.1 connects at a predetermined distance from the vehicle. If the wake-up signal W is received by the mobile communications unit 1.1, a link is established between the mobile communications unit 1.1 and the on-board control unit 1.2.

A transmitting antenna unit 1.1.2 is configured to transmit authorization data B that has been sent to the on-board control unit 1.2 in the form of a high-frequency identification signal to release the access authorization and/or driving authorization. The on-board control unit 1.2 then checks the authorization data B and grants the release of the access authorization and/or driving authorization is/are released upon successful authorization of the authorization data B.

The mobile communications unit 1.1 further comprises an evaluation unit 1.1.3, which is coupled with the antenna units 1.1.1, 1.1.2 to evaluate the received wake-up signal W and/or to generate the authorization data B that is to be transmitted. In the process, the vehicle functions, such as opening and closing motor-driven doors and hatches of the vehicle, activating and deactivating a driving motor of the vehicle as well as activating and deactivating illumination units and other signal units, can also be controlled by the evaluation unit 1.1.3. To this end, the mobile communications unit 1.1 has a plurality of actuation elements, e.g., buttons, not described in greater detail, which are coupled with the evaluation unit 1.1.3. The device 1 also has sensors in door handles, not described in greater detail, which permit the keyless opening and closing of vehicle doors.

Usually, the mobile communications unit 1.1, in particular the receiving antenna unit 1.1.1, is constantly ready to receive. The constant ready-to-receive state represents a risk for so-called relay attacks, in which, with the aid of two relay stations, the range of communication between the on-board control unit 1.2 and the mobile communications unit 1.1 is increased to an extent required for misuse.

In order improve the security of the device 1 and thus to protect the vehicle from theft, it is provided that the authorization data B are transmitted exclusively when, after the receipt of the wake-up signal W and thus the established link between the on-board control unit 1.2 and the mobile communications unit 1.1, a predefined knocking gesture is made on and detected by the mobile communications unit 1.1. This means, for example, that the user taps a knocking signal with a finger on a housing of the mobile communications unit 1.1. To this end, the mobile communications unit 1.1 can remain in any desired location on the user, such as in a trouser pocket. The knocking gesture in this instance can be predetermined by a vehicle manufacturer and can be modified individually by the user. When the mobile communications unit 1.1 detects the knocking gesture, the transmission of the authorization data B by the evaluation unit 1.1.3 is released.

To detect the knocking gesture, the mobile communications unit 1.1 has an acceleration sensor 1.1.4, which is coupled with the evaluation unit 1.1.3. Alternatively, or additionally, the mobile communications unit 1.1 has an acoustic sensor 1.1.5, such as a microphone, which is likewise coupled with the mobile communications unit 1.1.

The keyless access and driving authorization system of the vehicle can be reliably protected against relay attacks by the method. The risk of theft for the vehicle is thereby significantly reduced. In addition, the convenience for the user when unlocking and/or starting the vehicle is improved over the prior art.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-3. (canceled)

4. A method for controlling access authorization and/or driving authorization for a vehicle, the method comprising:
establishing a wireless link between a mobile communications unit and an on-board controller when to the mobile communications unit being located at a predetermined distance from the vehicle;
transmitting, by the mobile communications unit to the on-board controller, authorization data to release the access authorization and/or driving authorization; and
receiving and checking, by the on-board controller, the authorization data, wherein
the access authorization and/or driving authorization is/are released upon successful authorization of the authorization data by the on-board controller, and
the authorization data are transmitted from the mobile communications unit exclusively when, after the link between the mobile communications unit and the on-board controller has been established, a predefined or predefinable knocking gesture is made on and detected by the mobile communications unit.

5. The method of claim 4, wherein the knocking gesture is detected by an acceleration sensor of the mobile communications unit.

6. The method of claim 4, wherein the knocking gesture is detected by an acoustic sensor of the mobile communications unit.

7. A system for controlling access authorization and/or driving authorization for a vehicle, the system comprising:
a mobile communications unit; and
an on-board controller, wherein
the mobile communications unit and the on-board controller are configured to establish a wireless link between the mobile communications unit and the on-board controller when the mobile communications unit being located at a predetermined distance from the vehicle,
the mobile communications unit is configured to transmit authorization data to release the access authorization and/or driving authorization to the on-board controller,
the on-board controller is configured to receive and check the authorization data,
the on-board controller is configured to release the access authorization and/or driving authorization is/are released upon successful authorization of the authorization data by the on-board controller, and
the mobile communications unit is configured to transmit the authorization data exclusively when, after the link between the mobile communications unit and the on-board controller has been established, a predefined or predefinable knocking gesture is made on and detected by the mobile communications unit.

8. The system of claim 7, wherein the knocking gesture is detected by an acceleration sensor of the mobile communications unit.

9. The system of claim 7, wherein the knocking gesture is detected by an acoustic sensor of the mobile communications unit.
